(19) United States
(12) Patent Application Publication
(10) Pub. No.: US 2018/0253292 A1
(43) Pub. Date: Sep. 6, 2018

(54) BUILDING DEPLOYMENT PACKAGES THAT REFERENCE VERSIONS OF FILES TO BE DEPLOYED

(71) Applicant: International Business Machines Corporation, Armonk, NY (US)

(72) Inventors: Liam M. Doherty, Subiaco (AU); Luke R. McKenna, Willetton (AU); Jake P. Tucker, Safety Bay (AU); Peter D. Van Dyke, Woodlands (AU)

(21) Appl. No.: 15/446,482

(22) Filed: Mar. 1, 2017

(51) Int. Cl. G06F 9/445; G06F 9/44

(52) U.S. Cl. CPC G06F 8/60; G06F 8/71

(57) ABSTRACT

A computer-implemented method for deploying a build output package to a user includes: receiving a software build having a plurality of data sets and having a build version in a build output storage component; labeling each data set in the plurality of data sets with a unique identifier; receiving a package request requesting one or more data sets associated with the build version; building a package manifest that includes the unique identifier upon receiving the package request; copying each of the requested data sets and combining each of the copied data sets into a build output package based upon the package manifest, the copying and combining commencing upon building or completion of the package manifest; sending a copy of the build output package to the user; and deleting the build output package from the storage component in response to sending the copy of the build output package to the user.

### BACKGROUND

The present invention relates to deployment of software build outputs for testing or production for example.

A deployment package can contain a software build output at a certain point in time, which for example can be when the package was requested.

Many different developers may request similar deployment packages on the same processing system resulting in each requested package being stored in a storage component on that system. Depending on the size of each of the packages, multiple requested packages can result in taking up a large amount of storage capacity in the storage component.

Utilizing cloud technologies enables companies to scale elastically to cope with demand, reduce and rationalize information technology infrastructure, reduce the cost of operations and deploy systems faster, easier and on-demand.

### SUMMARY

Disclosed is a computer-implemented method for deploying a build output package to a user. The computer-implemented method includes: receiving a software build in a build output storage component of a deployment system, the software build comprising a plurality of data sets and having a build version; labeling each data set in the plurality of data sets with a unique identifier; receiving a package request requesting one or more data sets associated with the build version; building a package manifest that includes the unique identifier for the one or more data sets requested by the user upon receiving the package request; copying each of the requested data sets and combining each of the copied data sets into a build output package based upon the package manifest, the build output package being stored in the build output storage component, the copying and combining commencing upon building or completion of the package manifest; sending a copy of the build output package in the build output storage component to the user; and deleting the build output package stored in the build output storage component in response to sending the copy of the build output package to the user.

Also disclosed is a system for deploying a build output package to a user. The system includes a processor and a memory. The processor and memory are configured to: receive a software build in a build output storage component, the software build comprising a plurality of data sets and having a build version; label each data set in the received software build with a unique identifier; receive a package request requesting one or more data sets associated with the build version; build a package manifest that includes the unique identifier for the one or more data sets requested by the user upon receiving the package request; copy, in the build storage component, each of the requested data sets and combine each of the copied data sets into a build output package based upon the package manifest, the build output package being stored in the build output storage component, wherein the copy and the combine commence upon building or completion of the package manifest; send the build output package to the user from the build output storage component; and delete the build output package in the build output storage component in response to sending the build output package to the user.

Further disclosed is a computer program product for deploying a build output package to a user. The computer program product includes a computer readable storage medium having program instructions embodied therewith, the program instructions executable by a processor to cause the processor to: receive a software build in a build output storage component, the software build comprising a plurality of data sets and having a build version; label each data set in the received software build with a unique identifier; receive a package request requesting one or more data sets associated with the build version; build a package manifest that includes the unique identifier for the one or more data sets requested by the user upon receiving the package request; copy, in the build storage component, each of the requested data sets and combine each of the copied data sets into a build output package based upon the package manifest, the build output package being stored in the build output storage component, wherein the copy and the combine commence upon building or completion of the package manifest; send the build output package to the user from the build output storage component; and delete the build output package in the build output storage component in response to sending the build output package to the user.

The described aspects of the invention provide the advantage of enabling a build output deployment system to operate more quickly and efficiently by not cluttering a storage memory of the system with several repeat copies of software build outputs sent to users over the course of development of software. System speed is increased by not having to operate on or process the several repeat copies during system operation.

### BRIEF DESCRIPTION OF THE DRAWINGS

The subject matter regarded as the invention is particularly pointed out and distinctly claimed in the concluding portion of the specification. The invention, both as to organization and method of operation, together with objects, features, and advantages thereof, may best be understood by reference to the following detailed description when read with the accompanying drawings.

Exemplary embodiments of the present invention will now be described, by way of example only, with reference to the following drawings in which:

FIG. 1 is an embodiment of a software build;

FIG. 2 is a flow diagram of an example embodiment of a method for deploying a software build package to a user;

FIG. 3 is an embodiment of a build output deployment system;

FIG. 4 is a block diagram of an embodiment of a computer system or cloud server in which the present invention may be implemented;

FIG. 5 is a schematic diagram of a cloud computing environment in which the present invention may be implemented; and

FIG. 6 is a diagram of abstraction model layers of a cloud computing environment in which the present invention may be implemented.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numbers may be repeated among the figures to indicate corresponding or analogous features.

### DETAILED DESCRIPTION

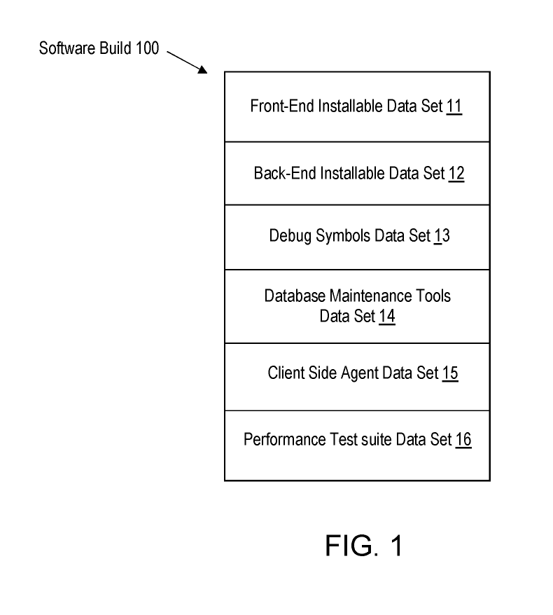

During software development, a software build is generated on a system. The term “software build” refers to tangible software that is being built for a certain purpose. FIG. 1 illustrates one example of a software build 100. The software build 100 may include a front-end installable data set 11, a back-end installable data set 12, a debug symbols data set 13, a database maintenance tools data set 14, a client side agent data set 15, and a performance test suite data set 16 as non-limiting embodiments. In one or more embodiments, the software build 100 can include other types of data sets and other numbers of data sets.

Build outputs are often required to be deployed from one system having the software build to other systems for testing, production, or other development actions. The term “build output” refers to all of the data sets in the software build or a subset of the data sets in the software build that are to be sent to a user. For example, one developer may request the front-end installable data set 11, the debug symbols data set 13, and the database maintenance tools data set 14 as a build output in one build output package. As another example, one tester may request the front-end installable data set 11, the database maintenance tools data set 14, and the performance test suite data set 16 as a build output in one build output package.

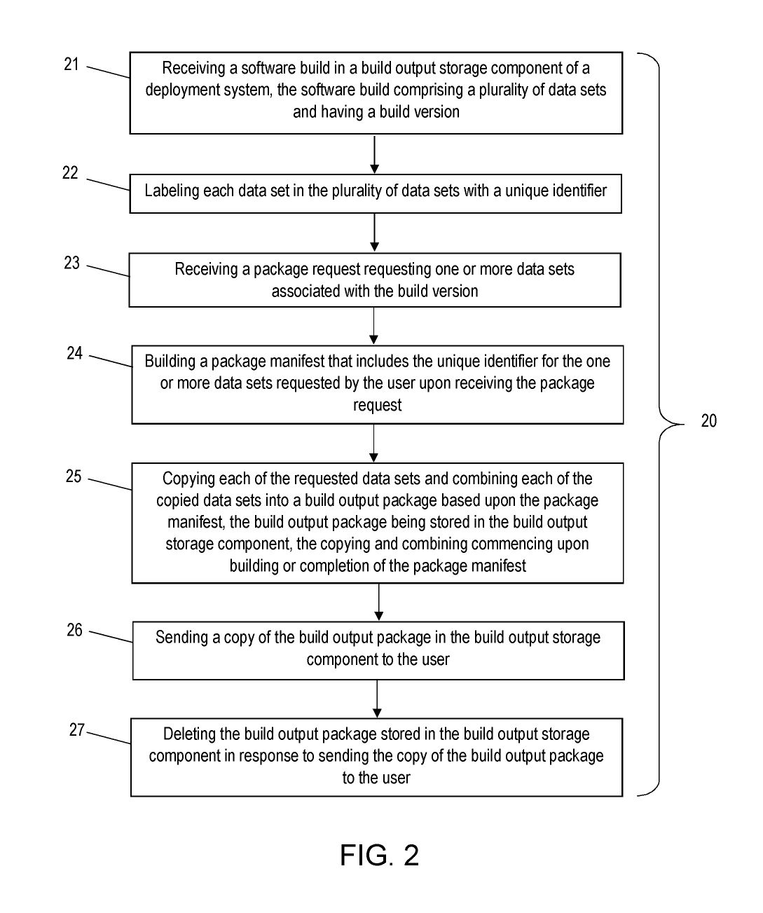

FIG. 2 is a flow diagram of an example embodiment of a method 20 for deploying a build output package to a user. Block 21 represents receiving a software build at a build output area of a system, the software build having a plurality of data sets and a build version. Block 22 represents labeling each data set in the received software build with a unique identifier. In one or more embodiments, the unique identifier is a Globally Unique Identifier (GUID).

Block 23 represents receiving a package request requesting one or more data sets associated with the build version. The term “build version” relates to a version of the build. The build version may be identified by an identifier such as an identifying number (e.g., 2.1). Each data set may also be identified with a version identifier. In one or more embodiments, the package request is sent to a packaging system that operates on the build output area. The package request can be entered using a user interface. In one or more embodiments, the user interface is configured to limit selection to only those versions of the data sets that are available in the build output area.

Block 24 represents building a package manifest that includes the unique identifier for the one or more data sets requested by the user upon receiving the package request. The term “upon receiving” relates to immediately starting a process to build the package manifest as soon as the package request is received so that the package manifest is built soon after receiving the package request.

Block 25 represents copying each of the requested data sets and combining each of the copied data sets into a build output package based upon the package manifest, the build output package being stored in the build output storage component, the copying and combining commencing upon building or completion of the package manifest. The term “upon building or completion of the package manifest” relates to starting a process of copying and combining as soon as the package manifest is in a process of being built or as soon as the package manifest is complete.

Block 26 represents sending a copy of the build output package in the build output storage component to the user sending the package request.

Block 27 represents deleting the build output package stored in the build output storage component in response to sending the copy of the build output package to the user. In one or more embodiments, the time at which the build output package is deleted is selectable by an administrator such as a build and packaging administrator. In one or more embodiments, the time at which the build output package is deleted is immediately following the sending the copy of the build output package to the user.

The method 20 may also include recording details of all package requests such as for example the unique identifiers, descriptive names of each data set, and requesting users. In one or more embodiments, the recorded details are stored in the build output storage component.

One advantage of the method 20 is that overwhelming the build output storage component with multiple copies of the same data sets that are used for deploying those data sets is avoided. Another advantage is that by limiting the amount of storage in the build output storage component the operational speed of the deployment system having the build output storage component is increased. Also, there is less need to use processes such as archival to manage the storage for the build output storage component.

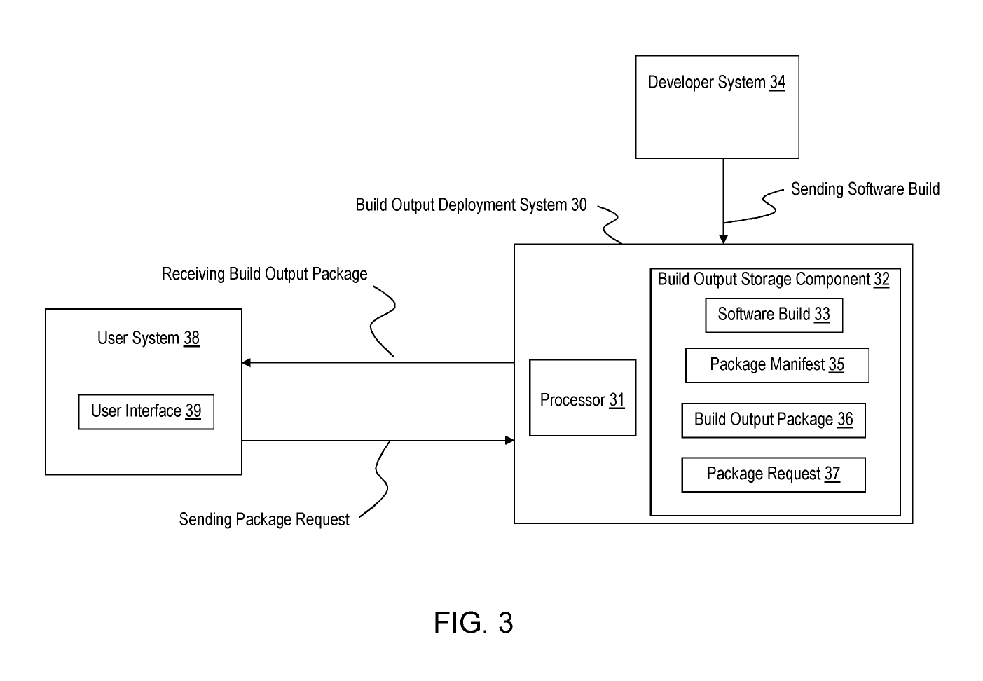

FIG. 3 illustrates an embodiment of a build output deployment system 30 for deploying a build out package to a user. The deployment system 30 includes a processor 31 and a build output storage component 32. The processor 31 is configured to process package requests, process building package manifests, process sending out build output packages, and process deleting build output packages from the build output storage component 32. The build output storage component 32 is configured to receive and store a software build 33 from a developer system 34. The build output storage component 32 is further configured to store a package manifest 35 used to build a build output package 36. The build output storage component 32 is further configured to store the build output package 36 in preparation for a copy of the build output package 36 being sent out to a requesting user. The deployment system 30 is configured to receive a package request 37 from a user system 38 and to send the build output package 36 to the user system 38. The build output storage component 32 is further configured to store details of the package request 37. The user system 38 includes a user interface 39 that is configured to send package requests to the deployment system 30. The user interface 39 may be configured to only allow package requests for data sets in software builds that are already stored in the build output storage component 32.

Information may be required to flow between disparate applications across multiple hardware and software platforms. One architecture which supports this is Enterprise Service Bus architecture providing integrated connectivity between applications and services in a service-oriented architecture. IBM Integration Bus (formerly WebSphere Message Broker, wherein IBM and WebSphere are trademarks of International Business Machines Corporation) is an example of such an architecture, which allows business information to flow as an integration application with rules applied to the data flowing through an integration node (also referred to as a message broker) to route and transform the information.

Other architectures may include distributed computing in which a distributed system is a software system in which components are located on networked computers and communicate and coordinate their actions by passing messages. Distributed applications may be processed across a distributed computing architecture.

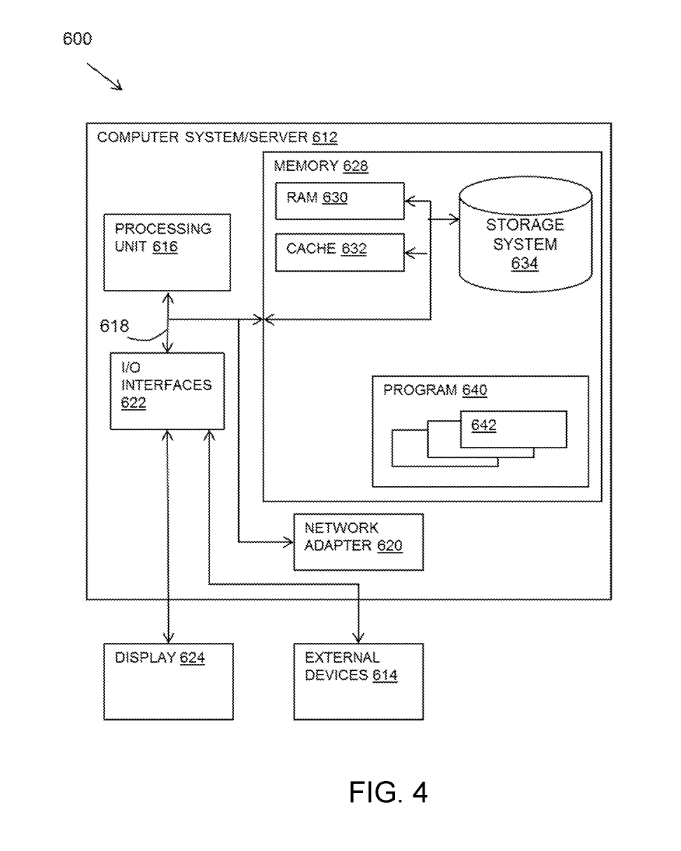

Referring now to FIG. 4, a schematic of an example of a system 600 in the form of a computer system or server is shown. The system 600 can represent the build output deployment system 30, the developer system 34, and/or the user system 38.

A computer system or server 612 may be operational with numerous other general purpose or special purpose computing system environments or configurations. Examples of well-known computing systems, environments, and/or configurations that may be suitable for use with computer system/server 612 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 612 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 612 may be practiced in distributed cloud computing environments where tasks are performed by remote processing devices that are linked through a communications network. In a distributed cloud computing environment, program modules may be located in both local and remote computer system storage media including memory storage devices.

In FIG. 4, a computer system/server 612 is shown in the form of a general-purpose computing device. The components of the computer system/server 612 may include, but are not limited to, one or more processors or processing units 616, a system memory 628, and a bus 618 that couples various system components including system memory 628 to processor 616.

Bus 618 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 612 typically includes a variety of computer system readable media. Such media may be any available media that is accessible by computer system/server 612, and it includes both volatile and non-volatile media, removable and non-removable media.

System memory 628 can include computer system readable media in the form of volatile memory, such as random access memory (RAM) 630 and/or cache memory 632. Computer system/server 612 may further include other removable/non-removable, volatile/non-volatile computer system storage media. By way of example only, storage system 634 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 618 by one or more data media interfaces. As will be further depicted and described below, memory 628 may include at least one program product having a set (e.g., at least one) of program modules that are configured to carry out the functions of embodiments of the invention.

Program/utility 640, having a set (at least one) of program modules 642, may be stored in memory 628 by way of example, and not limitation, as well as an operating system, one or more application programs, other program modules, and program data. Each of the operating system, one or more application programs, other program modules, and program data or some combination thereof, may include an implementation of a networking environment. Program modules 642 generally carry out the functions and/or methodologies of embodiments of the invention as described herein.

Computer system/server 612 may also communicate with one or more external devices 614 such as a keyboard, a pointing device, a display 624, etc.; one or more devices that enable a user to interact with computer system/server 612; and/or any devices (e.g., network card, modem, etc.) that enable computer system/server 612 to communicate with one or more other computing devices. Such communication can occur via Input/Output (I/O) interfaces 622. Still yet, computer system/server 612 can communicate with one or more networks such as a local area network (LAN), a general wide area network (WAN), and/or a public network (e.g., the Internet) via network adapter 620. As depicted, network adapter 620 communicates with the other components of computer system/server 612 via bus 618. It should be understood that although not shown, other hardware and/or software components could be used in conjunction with computer system/server 612. Examples, include, but are not limited to: microcode, device drivers, redundant processing units, external disk drive arrays, RAID systems, tape drives, and data archival storage systems, etc.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

### Cloud Computing

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

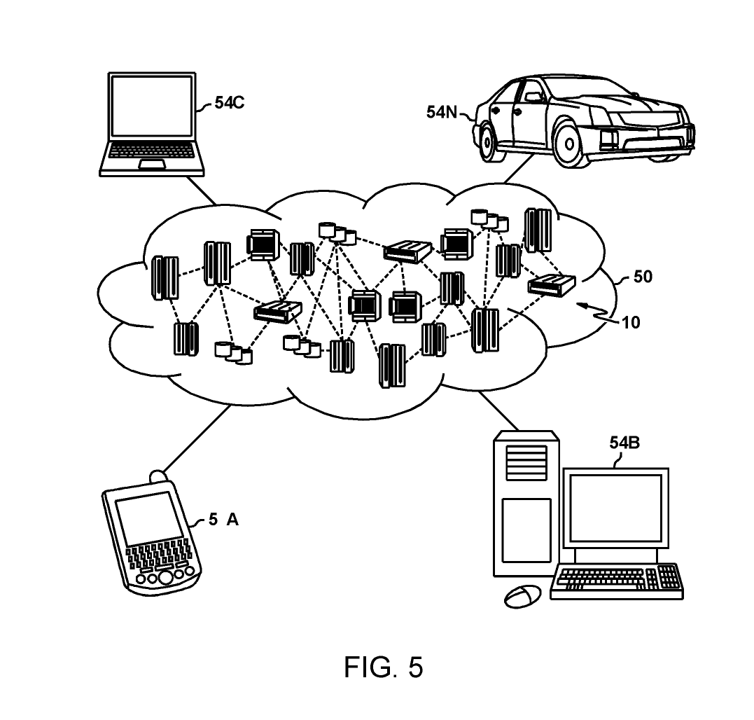

Referring now to FIG. 5, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 5 are intended to be illustrative only and that computing nodes 10 and cloud computing environment 50 can communicate with any type of computerized device over any type of network and/or network addressable connection (e.g., using a web browser).

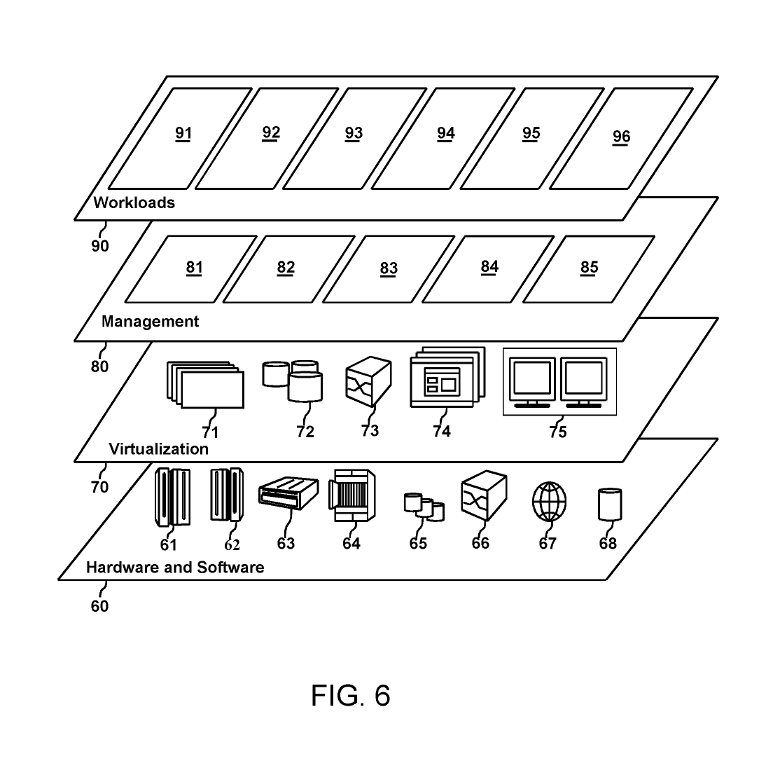

Referring now to FIG. 6, a set of functional abstraction layers provided by cloud computing environment 50 (FIG. 5) is shown. It should be understood in advance that the components, layers, and functions shown in FIG. 6 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and software build output deployment 96 for deployment across deployment locations.

Elements of the embodiments have been introduced with either the articles “a” or “an.” The articles are intended to mean that there are one or more elements. The terms “including” and “having” and the like are intended to be inclusive such that there may be additional elements other than the elements listed. The term “configured” relates to one or more structural limitations of a device that are required for the device to perform the function or operation for which the device is configured.

The disclosure illustratively disclosed may be practiced in the absence of any element which is not specifically disclosed.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method for deploying a build output package to a user, comprising:
receiving a software build in a build output storage component of a deployment system, the software build comprising a plurality of data sets and having a build version;
labeling each data set in the plurality of data sets with a unique identifier;
receiving a package request requesting one or more data sets associated with the build version;
building a package manifest that includes the unique identifier for the one or more data sets requested by the user upon receiving the package request;
copying each of the requested data sets and combining each of the copied data sets into a build output package based upon the package manifest, the build output package being stored in the build output storage component, the copying and combining commencing upon building or completion of the package manifest;
sending a copy of the build output package in the build output storage component to the user; and
deleting the build output package stored in the build output storage component in response to sending the copy of the build output package to the user.

2. The method as claimed in claim 1, further comprising recording details of package requests.

3. The method as claimed in claim 2, wherein the details comprise at least one of unique identifier, data set descriptive name, and requesting user.

4. The method as claimed in claim 2, wherein the details are stored in the build output storage component.

5. The method as claimed in claim 1, further comprising sending the package request from a user system and receiving the build output package at the user system.

6. The method as claimed in claim 5, wherein the user system comprises a user interface configured to only allow package requests for data sets that are in the build output storage component.

7. The method as claimed in claim 1, wherein at least a portion of the method is capable of being deployed in a cloud computing environment.

8. A system for deploying a build output package to a user, comprising:
a processor and a memory configured to:
receive a software build in a build output storage component, the software build comprising a plurality of data sets and having a build version;
label each data set in the received software build with a unique identifier;
receive a package request requesting one or more data sets associated with the build version;
build a package manifest that includes the unique identifier for the one or more data sets requested by the user upon receiving the package request;
copy, in the build storage component, each of the requested data sets and combine each of the copied data sets into a build output package based upon the package manifest, the build output package being stored in the build output storage component, wherein the copy and the combine commence upon building or completion of the package manifest;
send the build output package to the user from the build output storage component; and
delete the build output package in the build output storage component in response to sending the build output package to the user.

9. The system as claimed in claim 8, wherein the processor is further configured to record details of package requests.

10. The system as claimed in claim 9, wherein the details comprise at least one of a unique identifier, a data set descriptive name, and a requesting user.

11. The system as claimed in claim 8, further comprising a user system configured to send the package request and receive the build output package.

12. The system as claimed in claim 11, wherein the user system comprises a user interface configured to only allow package requests for data sets that are in the build output storage component.

13. The system as claimed in claim 8, wherein the system is part of a cloud computing environment.

14. A computer program product for deploying a build output package to a user, the computer program product comprising a computer readable storage medium having program instructions embodied therewith, the program instructions executable by a processor to cause the processor to:
receive a software build in a build output storage component, the software build comprising a plurality of data sets and having a build version;
label each data set in the received software build with a unique identifier;
receive a package request requesting one or more data sets associated with the build version;
build a package manifest that includes the unique identifier for the one or more data sets requested by the user upon receiving the package request;
copy, in the build storage component, each of the requested data sets and combine each of the copied data sets into a build output package based upon the package manifest, the build output package being stored in the build output storage component, wherein the copy and the combine commence upon building or completion of the package manifest;
send the build output package to the user from the build output storage component; and
delete the build output package in the build output storage component in response to sending the build output package to the user.

15. The computer program product as claimed in claim 14, wherein the program instructions cause the processor to record details of package requests.

16. The computer program product as claimed in claim 15, wherein the details comprise at least one of a unique identifier, a data set descriptive name, and a requesting user.

17. The computer program product as claimed in claim 14, the program instructions cause the processor to receive the package request from a user system and to send the build output package to the user system.

18. The computer program product as claimed in claim 17, wherein the user system comprises a user interface configured to only allow package requests for data sets that are in the build output storage component.

19. The computer program product as claimed in claim 14, wherein the computer program product is part of a cloud computing environment.
